(19) United States
(12) Patent Application Publication
(10) Pub. No.: US 2009/0075225 A1
(43) Pub. Date: Mar. 19, 2009

(54) HEATING APPARATUS AND HEATING METHOD

(75) Inventors: Masayuki Nakagiri, Shizuoka-ken (JP); Ryoichi Sugihara, Shizuoka-ken (JP); Nobuyasu Akiyoshi, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/913,258

(22) PCT Filed: May 19, 2006
(86) PCT No.: PCT/JP2006/310502

§ 371 Date: Oct. 31, 2007

(30) Foreign Application Priority Data
May 20, 2005 (JP) 2005-147908
Jul. 22, 2005 (JP) 2005-213045

(51) Int. Cl. F27B 9/02

(52) U.S. Cl. 432/18; 432/128

(57) ABSTRACT

A heating apparatus has first through fifth heating furnace arranged along the feeding direction in which glass substrates are fed by a feeding mechanism. The first heating furnace has a first heater for heating a glass substrate to at least a target temperature required for processing the workpiece. The second heating furnace has a heater for heating a glass substrate to a temperature equal to or below the target temperature. The second heating furnace generates an amount of heat smaller than that of the first heating furnace.

### TECHNICAL FIELD

The present invention relates to a heating apparatus having a feed mechanism for feeding a workpiece to be processed, and a heating method to be carried out by such a heating apparatus.

### BACKGROUND

Substrates for liquid crystal panels, substrates for printed wiring boards, and substrates for PDP panels, for example, comprise a photosensitive laminated body including a photosensitive sheet (photosensitive web) having a photosensitive material (photosensitive resin) layer and applied to substrate surfaces. The photosensitive sheet comprises a photosensitive material layer and a protective film that are successively deposited on a flexible plastic support.

To manufacture the photosensitive laminated body, a substrate (a workpiece to be processed) such as a glass substrate, a resin substrate, or the like is usually preheated to a predetermined temperature. A photosensitive web from which a protective film has partly or entirely been peeled off and the preheated substrate are gripped between and heated by a pair of laminating rollers to thermally compress the photosensitive material against the substrate. Then, the flexible plastic support is peeled off the substrate, thereby producing the photosensitive laminated body.

For heating a substrate to a predetermined temperature, a continuously heating apparatus disclosed in Japanese Laid-Open Patent Publication No. 5-208261, for example, may be employed. In the disclosed continuously heating apparatus, as shown in FIG. 19 of the accompanying drawings, a substrate 1 is placed on a circulating mesh belt 2 and continuously fed in the direction indicated by the arrow X. The continuously heating apparatus has a preheating region 3, a reflow region 4, and a cooling region 5 which are successively disposed along the direction in which the substrate 1 is fed.

The preheating region 3 has a set of preheating planar heaters 3a, 3b, 3c positioned above and below the substrate 1 and successively disposed along the direction indicated by the arrow X. The reflow region 4 has a pair of chambers 7 each defined by heat shield plates 6a, 6b, 6c, and a pair of reflow heaters 8 disposed respectively in the chambers 7.

The substrate 1, which has devices mounted on a printed-circuit board by solder, is heated in the reflow region 4 to a given temperature equal to or higher than the melting point of solder, e.g., to 210° C. if the solder has a melting point of 180° C., for 15 to 30 seconds. In the preheating region 3, the substrate 1 is preheated to a temperature in the range from 140° C. to 160° C.

According to the above conventional heating apparatus, it is necessary to prevent the substrate 1 from being heated beyond the above preheating temperature in the preheating region 3. Each of the planar heaters 3a, 3b, 3c is controlled to set its temperature to a relatively low temperature so that the converged temperature of the heated substrate 1 will not reach an excessive temperature, e.g., 220° C.

However, since the substrate 1 is heated from a normal temperature of about 20° C. to the preheating temperature in the range from 140° C. to 160° C., the substrate 1 is heated for a considerably long period of time. If the substrate 1 is be fed in a shorter tact time, then the preheating region 3 is considerably elongated in the feeding direction, tending to make the heating apparatus larger in size.

### DISCLOSURE OF INVENTION

It is a major object of the present invention to provide a heating apparatus which is capable of quickly and reliably heating a workpiece up to a predetermined temperature and which is relatively compact in size, and a heating method to be carried out by such a heating apparatus.

An apparatus for heating a workpiece according to the present invention has a feed mechanism for feeding the workpiece in a feeding direction. The apparatus has at least first and second heating furnaces disposed along the feeding direction. The first heating furnace is disposed upstream of the second heating furnace with respect to the feeding direction and has a first heat source for heating the workpiece to at least a target temperature required for processing the workpiece. The second heating furnace capable of generating a smaller amount of heat than that of the first heating furnace is disposed downstream of the first heating furnace with respect to the feeding direction and has a second heat source for heating the workpiece to a temperature lower than the target temperature.

Either the second heating furnace or one of heating furnaces including a third heating furnace disposed downstream of the second heating furnace with respect to the feeding direction may have a retracting mechanism for retracting the workpiece from the feed mechanism. The retracting mechanism may include a buffer for receiving the workpiece delivered vertically or horizontally in a direction perpendicular to the feeding direction.

The apparatus may further comprise a buffer disposed downstream of the first heating furnace with respect to the feeding direction, for holding the workpiece or a downstream workpiece to wait therein only when it is judged that the workpiece has been heated beyond a predetermined period of time in the first heating furnace. The feed mechanism may continuously or intermittently feed the workpiece.

Either the second heating furnace or one of heating furnaces including a third heating furnace disposed downstream of the second heating furnace with respect to the feeding direction may have a positioning mechanism for positioning the workpiece transversely thereof in a direction transverse to the feeding direction, and for stopping the workpiece in a predetermined position along the feeding direction.

According to the present invention, there is also provided a method of heating a workpiece while intermittently or continuously feeding the workpiece along a feed path, comprising the steps of: heating the workpiece to a temperature equal to or lower than a target temperature with a first heating furnace disposed in an upstream area with respect to the feeding direction and being capable of heating the workpiece to at least the target temperature required for processing the workpiece, and heating the workpiece to a temperature equal to or lower than the target temperature with a second heating furnace disposed in a downstream area with respect to the feeding direction and being capable of generating a smaller amount of heat than that of the first heating furnace.

A buffer for retracting the workpiece from the feed path may be disposed in either the second heating furnace or one of a plurality of heating furnaces including a third heating furnace disposed downstream of the second heating furnace with respect to the feeding direction. The method may further comprise the steps of, when it is judged that the workpiece has been heated beyond a predetermined period of time in the first heating furnace, delivering the workpiece or another workpiece from the feed path into the buffer, and discharging the workpiece from the first heating furnace.

The buffer may be disposed transversely to the feed path. The method may further comprise the steps of, when it is judged that the workpiece has been heated beyond a predetermined period of time in the first heating furnace, delivering a previously provided first workpiece into the buffer, thereafter placing a subsequently provided second workpiece in parallel to the first workpiece, returning the first workpiece to the feed path, separating the second workpiece from the feed path, then feeding the first workpiece along the feed path, thereafter returning the second workpiece to the feed path, and feeding the second workpiece along the feed path after the first workpiece.

The buffer may comprise first and second buffers arranged along the feed path. The method may further comprise the steps of, when it is judged that the workpiece has been heated beyond a predetermined period of time in the first heating furnace, delivering a previously provided first workpiece from the feed path into the first buffer, thereafter delivering a subsequently provided second workpiece through the first buffer into the second buffer, returning the first workpiece from the first buffer to the feed path, feeding the first workpiece downstream along the feed path, then returning the second workpiece from the second buffer to the feed path, and feeding the second workpiece along the feed path after the first workpiece.

A buffer may be disposed downstream of the first heating furnace with respect to the feeding direction, and the method may further comprise the step of, only when it is judged that the workpiece has been heated beyond a predetermined period of time in the first heating furnace, holding the workpiece or a downstream workpiece to wait in the buffer.

The method may further comprise the steps of positioning the workpiece transversely thereof in a direction transverse to the feeding direction in either the second heating furnace or one of a plurality of heating furnaces including a third heating furnace disposed downstream of the second heating furnace with respect to the feeding direction, and stopping the workpiece in a predetermined position along the feeding direction, and thereafter detecting whether the workpiece is stopped in the predetermined position or not.

According to the present invention, the first heating furnace which is disposed upstream of the second heating furnace with respect to the feeding direction generates a greater amount of heat than that of the second heating furnace, and quickly heats the workpiece nearly to the target temperature. The workpiece can thus be heated in a short period of time, the overall length of the heating furnaces is short, and the heating apparatus is small in size.

The second heating furnace which generates a smaller amount of heat than that of the first heating furnace is disposed downstream of the first heating furnace. Therefore, the workpiece which has been quickly been heated closely to the target temperature by the first heating furnace can accurately be heated to the target temperature by the second heating furnace.

Even if the workpiece dwells in the second heating furnace, therefore, it is not heated beyond the target temperature. When the feeding of the workpiece in the apparatus is stopped because of trouble or maintenance of the apparatus, it is reliably possible to prevent the workpiece from being heated beyond the target temperature simply by delivering the workpiece from the first heating furnace to the second heating furnace.

After the workpiece has been recovered from the dwelling state, the workpiece that is kept at the target temperature can be supplied. Consequently, the apparatus operates efficiently, and does not require a cooling device for cooling the workpiece which would otherwise been heated excessively. The workpiece which would otherwise been heated excessively does not need to be taken out of the apparatus, and a new workpiece does not need to be provided into the apparatus. In addition, the apparatus is free of an operation loss or a workpiece loss due to excessively heated workpieces.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a schematic side elevational view of a manufacturing apparatus which incorporates a heating apparatus according to a first embodiment of the present invention;

FIG. 2 is an enlarged fragmentary cross-sectional view of an elongate photosensitive web used in the manufacturing apparatus shown in FIG. 1;

FIG. 3 is an enlarged fragmentary plan view of the elongate photosensitive web with adhesive labels bonded thereto;

FIG. 4 is a schematic side elevational view of the heating apparatus;

FIG. 5 is an enlarged side elevational view of a retracting mechanism of the heating apparatus;

FIG. 6 is a perspective view of the retracting mechanism;

FIG. 7 is a perspective view of a positioning mechanism of the heating apparatus:

FIG. 8 is a plan view of a stopping mechanism of the heating apparatus:

FIG. 9 is a diagram showing temperature increasing patterns of the heating apparatus according to the first embodiment and the conventional heating apparatus;

FIG. 10 is a schematic side elevational view of a heating apparatus according to a second embodiment of the present invention;

FIG. 11 is a plan view of a heating apparatus according to a third embodiment of the present invention;

FIG. 12 is a perspective view of the heating apparatus shown in FIG. 11;

FIG. 13 is a schematic side elevational view of a heating apparatus according to a fourth embodiment of the present invention;

FIG. 14 is a diagram illustrative of a heating furnace setting temperature of the heating apparatus shown in FIG. 13 and the manner in which the temperature of a glass substrate rises;

FIG. 15 is a schematic side elevational view showing the manner in which the heating apparatus operates to retract a glass substrate into a first buffer;

FIG. 16 is a schematic side elevational view showing the manner in which the heating apparatus operates after a glass substrate has recovered from a dwelling state;

FIG. 17 is a schematic side elevational view showing the manner in which the heating apparatus operates to retract a subsequent glass substrate into a second buffer;

FIG. 18 is a schematic side elevational view of a heating apparatus according to a fifth embodiment of the present invention; and

FIG. 19 is a schematic side elevational view of a conventional continuously heating apparatus.

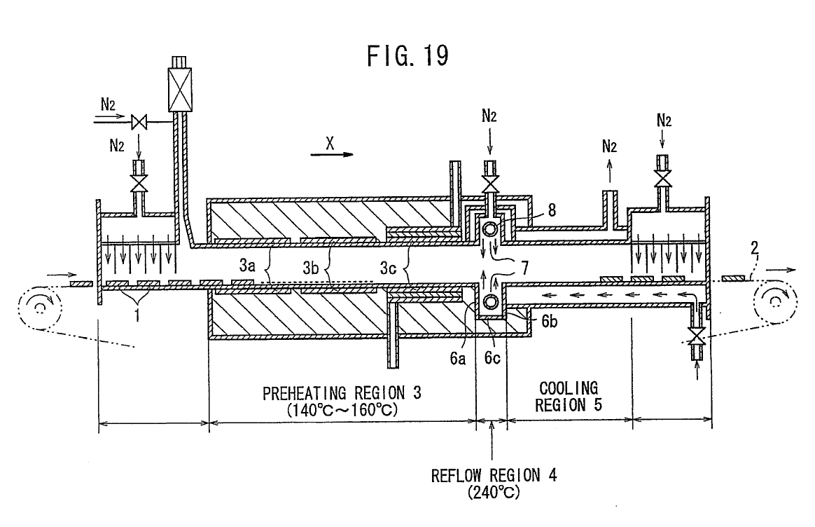

### BEST MODE FOR CARRYING OUT THE INVENTION

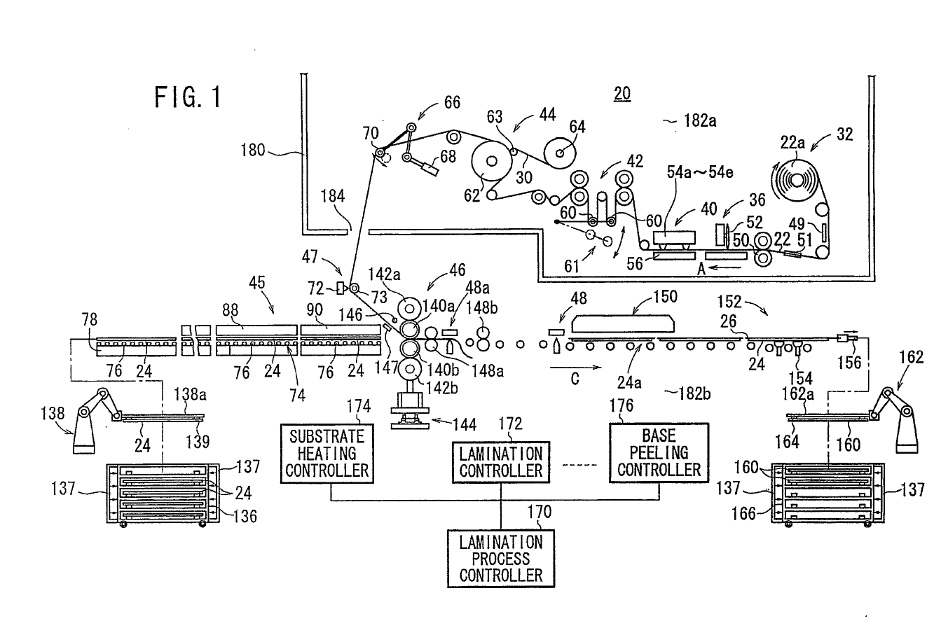

FIG. 1 schematically shows a manufacturing apparatus 20 for photosensitive laminate which incorporates a heating apparatus according to a first embodiment of the present invention. The manufacturing apparatus 20 operates to thermally transfer a photosensitive resin layer 28 (described later) of an elongate photosensitive web 22 to glass substrates 24 in a process of manufacturing liquid crystal panels or color filters for use with organic EL panels.

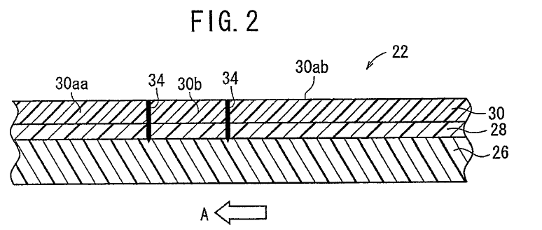

FIG. 2 shows in cross section the photosensitive web 22 that is employed in the manufacturing apparatus 20. The photosensitive web 22 comprises a laminated assembly of a flexible base film (support layer) 26, a photosensitive resin layer (photosensitive material layer) 28 disposed on the flexible base film 26, and a protective film 30 disposed on the photosensitive resin layer 28.

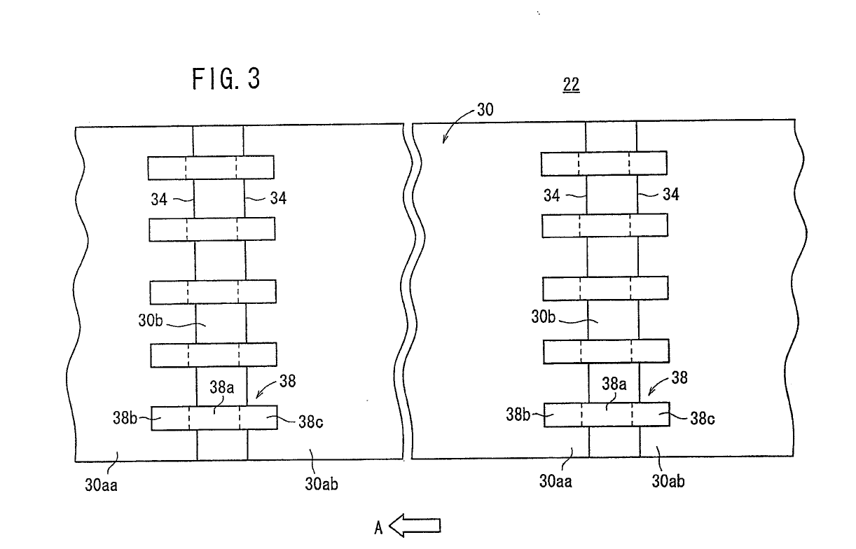

As shown in FIG. 1, the manufacturing apparatus 20 has a web reel-out mechanism 32 for accommodating a photosensitive web roll 22a in the form of the rolled photosensitive web 22 and reeling out the photosensitive web 22 from the photosensitive web roll 22a, a processing mechanism 36 for forming transversely severable partly cut regions 34 in the protective film 30 of the photosensitive web 22 that has been reeled out, and a label bonding mechanism 40 for bonding adhesive labels 38 (see FIG. 3), each having a non-sticky portion 38a, to the protective film 30.

Downstream of the label bonding mechanism 40, there are disposed a reservoir mechanism 42 for changing the feed mode of the photosensitive web 22 from a tact feed mode, i.e., an intermittent feed mode, to a continuous feed mode, a peeling mechanism 44 for peeling certain lengths of the protective film 30 from the photosensitive web 22, a heating apparatus 45 according to the first embodiment of the present invention for heating a glass substrate 24 to a predetermined temperature and feeding the heated glass substrate 24 to a bonding position, and a bonding mechanism 46 for bonding the photosensitive resin layer 28 which has been exposed by peeling off the protective film 30 to the glass substrate 24. A workpiece which is constructed of the glass substrate 24 and the photosensitive web 22 bonded thereto by the bonding mechanism 46 will hereinafter be referred to as “substrate 24a”.

A detecting mechanism 47 for directly detecting partly cut regions 34 which are positioned at a boundary on the photosensitive web 22 is disposed upstream of and near the bonding position in the bonding mechanism 46. An inter-substrate web cutting mechanism 48 for cutting the photosensitive web 22 between two adjacent substrates 24 is disposed downstream of the bonding mechanism 46. A web cutting mechanism 48a which is operated when the manufacturing apparatus 20 starts and ends its operation is disposed upstream of the inter-substrate web cutting mechanism 48.

A joining base 49 for joining the trailing end of a photosensitive web 22 that has essentially been used up and the leading end of a photosensitive web 22 that is to be newly used is disposed downstream of and closely to the web reel-out mechanism 32. The joining base 49 is followed downstream by a film end position detector 51 for controlling a transverse shift of the photosensitive web 22 due to a winding irregularity of the photosensitive web roll 22a.

The processing mechanism 36 is disposed downstream of a pair of rollers 50 for calculating the diameter of the photosensitive web roll 22a wound in the web reel-out mechanism 32. The processing mechanism 36 comprises a single circular blade 52 which travels transversely across the photosensitive web 22 to form partly cut regions 34 in the photosensitive web 22 at a predetermined position thereon.

As shown in FIG. 2, the partly cut regions 34 need to be formed across at least the protective film 30. Actually, the circular blade 52 is designed to cut into the photosensitive resin layer 28 and the base film 26 in order to reliably cut the protective film 30. The circular blade 52 may be fixed, rather than rotated, and move transversely across the photosensitive web 22 to form the partly cut regions 34 therein, or may be rotated without sliding on the photosensitive web 22, and move transversely across the photosensitive web 22 to form the partly cut regions 34 therein. The partly cut regions 34 may be formed by a cutting process using a laser beam or ultrasonic energy, or a cutting process using a knife blade, a pressing blade (Thompson blade), or the like.

The partly cut regions 34 serve to set a spaced interval between two adjacent glass substrates 24. For example, these partly cut regions 34 are formed in the protective film 30 at positions that are 10 mm spaced inwardly from respective edges of the glass substrates 24. The section of the protective film 30 which is interposed between the partly cut regions 34 and exposed between the glass substrates 24 functions as a mask when the photosensitive resin layer 28 is applied as a frame to the glass substrate 24 in the bonding mechanism 46 to be described later.

The label bonding mechanism 40 supplies adhesive labels 38 for interconnecting a front peel-off section 30aa and a rear peel-off section 30ab in order to leave a residual section 30b of the protective film 30 between glass substrates 24. As shown in FIG. 2, the front peel-off section 30aa which is to be peeled off initially and the rear peel-off section 30ab which is to be peeled off subsequently are positioned on respective sides of the residual section 30b.

As shown in FIG. 3, each of the adhesive labels 38 is of a rectangular strip shape and is made of the same resin material as the protective film 30. Each of the adhesive labels 38 has a non-sticky (or slightly adhesive) portion 38a positioned centrally which is free of an adhesive, and a first adhesion area 38b and a second adhesion area 38c which are disposed respectively on the longitudinally opposite ends of the non-sticky portion 38a, i.e., on the longitudinally opposite end portions of the adhesive label 38, the first adhesion area 38b and the second adhesion area 38c being bonded respectively to the front peel-off section 30aa and the rear peel-off section 30ab.

As shown in FIG. 1, the label bonding mechanism 40 has suction pads 54a through 54e for applying a maximum of five adhesive labels 38 at predetermined intervals. A support base 56 that is vertically movable for holding the photosensitive web 22 from below is disposed in a position where adhesive labels 38 are applied to the photosensitive web 22 by the suction pads 54a through 54e.

The reservoir mechanism 42 serves to absorb a speed difference between the tact feed mode in which the photosensitive web 22 is fed upstream of the reservoir mechanism 42 and the continuous feed mode in which the photosensitive web 22 is fed downstream of the reservoir mechanism 42. The reservoir mechanism 42 also has a dancer 61 comprising two swingable rollers 60 for preventing the photosensitive web 22 from suffering tension variations. The dancer 61 may have one or three or more rollers 60 depending on the length of the photosensitive web 22 to be reserved.

The peeling mechanism 44 which is disposed downstream of the reservoir mechanism 42 has a suction drum 62 for reducing variations of the tension to which the supplied photosensitive web 22 is subjected for thereby stabilizing the tension of the photosensitive web 22 when it is subsequently laminated. The peeling mechanism 44 also has a peeling roller 63 disposed closely to the suction drum 62. The protective film 30 that is peeled off from the photosensitive web 22 at a sharp peel-off angle is wound, except a residual section 30b, by a protective film takeup unit 64.

A tension control mechanism 66 for imparting tension to the photosensitive web 22 is disposed downstream of the peeling mechanism 44. The tension control mechanism 66 has a cylinder 68 that is actuatable to angularly displace a tension dancer 70 to adjust the tension of the photosensitive web 22 that the tension dancer 70 is held in rolling contact with. The tension control mechanism 66 may be employed only when necessary, and may be dispensed with.

The detecting mechanism 47 has a photoelectric sensor 72 such as a laser sensor, a photosensor, or the like for directly detecting a change in the photosensitive web 22 due to wedge-shaped grooves in the partly cut regions 34, steps produced by different thicknesses of the protective films 30, or a combination thereof. A detected signal from the photoelectric sensor 72 is used as a boundary position signal representative of the boundary position in the protective film 30. The photoelectric sensor 72 is disposed in confronting relation to a backup roller 73.

Alternatively, a non-contact displacement gauges or an image inspecting means such as a CCD camera or the like may be employed instead of the photoelectric sensor 72.

The positional data of the partly cut regions 34 which are detected by the detecting mechanism 47 can be statistically processed and converted into graphic data in real time. When the positional data detected by the detecting mechanism 47 show an undue variation or bias, the manufacturing apparatus 20 may generate a warning.

The manufacturing apparatus 20 may employ a different system for generating boundary position signals. According to such a different system, the partly cut regions 34 are not directly detected, but marks are applied to the photosensitive web 22. For example, holes or recesses may be formed in the photosensitive web 22 near the partly cut regions 34 in the vicinity of the processing mechanism 36, or the photosensitive web 22 may be slit by a laser beam or an aqua jet or may be marked by an ink jet or a printer. The marks on the photosensitive web 22 are detected, and detected signals are used as boundary position signals.

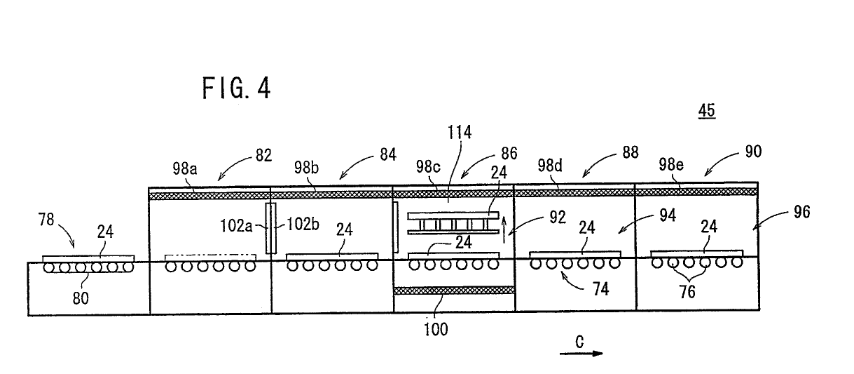

As shown in FIG. 4, the heating apparatus 45 has a feed mechanism 74 for feeding glass substrates 24 as workpieces in the direction indicated by the arrow C. The feed mechanism 74 has a plurality of disk-shaped resin feed rollers 76 that are arrayed in the direction indicated by the arrow C. The heating apparatus 45 also has a receiver 78 for receiving glass substrates 24 which is disposed upstream of the feed mechanism 74 in the direction indicated by the arrow C. The receiver 78 has a turntable 80 for turning a received glass substrate 24.

The heating apparatus further includes at least first and second heating furnaces, or first through fifth heating furnaces 82, 84, 86, 88, 90 in the first embodiment. The first heating furnace 82 serves as a high-temperature furnace. The second heating furnace 84 serves as a temperature-increasing furnace. The third heating furnace 86 serves as a temperature-increasing furnace and retracting mechanism 92. The fourth heating furnace 88 serves as a thermal insulation furnace and positioning mechanism 94. The fifth heating furnace 90 serves as a thermal insulation furnace and stopping mechanism 96.

Specifically, the first heating furnace 82 has a first heater (first heat source) 98a. In the first heating furnace 82, the first heater 98a heats a glass substrate 24 to a temperature of at least 110° C., e.g., 120° C., required for lamination. The heater temperature of the first heater 98a is set to 200° C. or higher, for example.

The second through fifth heating furnaces 84 through 90, which generate amounts of heat smaller than that of the first heating furnace 82 have respective second through fifth heaters (second heat source) 98b through 98e. The heater temperatures of the second through fifth heaters 98b through 98e are set to about 130° C. such that even when a glass substrate 24 dwells in the second through fifth heating furnaces 84 through 90 longer than a predetermined period of time, the glass substrate 24 is not heated higher than an upper limit substrate temperature, e.g., 130° C.

The surface of each glass substrate 24 is coated with a surface contact improver such as a silane coupling agent or the like. Therefore, the upper limit substrate temperature is preferably set to a temperature at which the quality of the surface contact improver does not deteriorate, e.g., 130° C.

The third heating furnace 86 has an auxiliary heater 100 positioned below the feed mechanism 74. The auxiliary heater 100 has a heater temperature set to about 115° C. Heat shield plates 102a, 102b are disposed between the first heating furnace 82 and the second heating furnace 84 for preventing the high temperature in the first heating furnace 82 from adversely affecting the second heating furnace 84. Each of the heat shield plates 102a, 102b comprises a fixed plate of stainless steel, for example. However, each of the heat shield plates 102a, 102b may comprise a heat insulation plate such as ceramics or the like, or may be replaced with an openable and closable shutter structure, an air curtain, or the like.

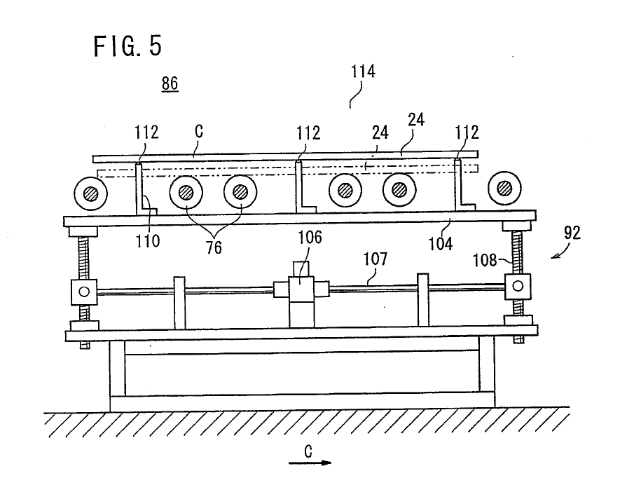

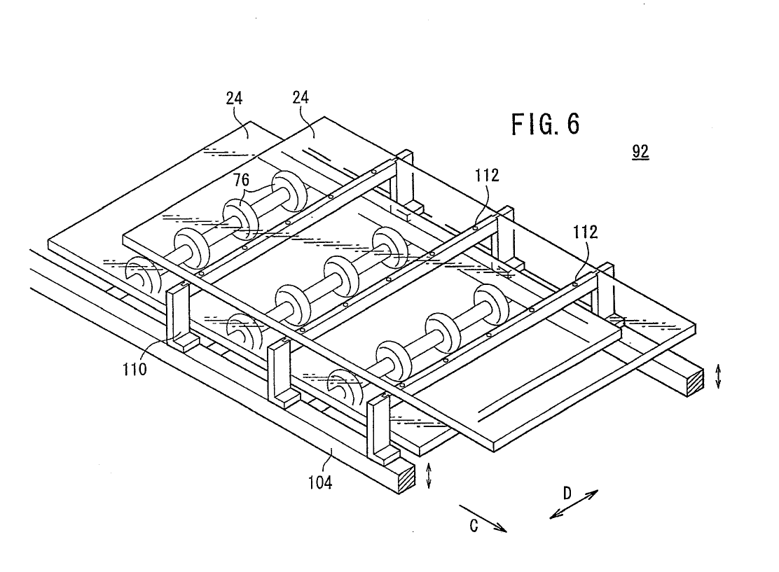

As shown in FIG. 5, the retracting mechanism 92 has a vertically movable support table 104 engaging feed screws 108 which are vertically movable by a drive force transmitting device 107 coupled to a motor 106. A plurality of vertical support posts 110 are fixedly mounted on the support base 104 at predetermined intervals. As shown in FIG. 6, a plurality of bearing pins 112 that are spaced at predetermined intervals in the direction indicated by the arrow D, which is perpendicular to the feeding direction indicated by the arrow C, are disposed on upper surfaces of the support posts 110. The bearing pins 112 are made of resin, for example, have round tip ends for supporting a glass substrate 24 thereon.

The retracting mechanism 92 has a buffer 114 for supporting a glass substrate 24 that is fed in the direction indicated by the arrow C by the feed mechanism 74 and delivering the glass substrate 24 vertically upwardly (see FIGS. 4 and 5).

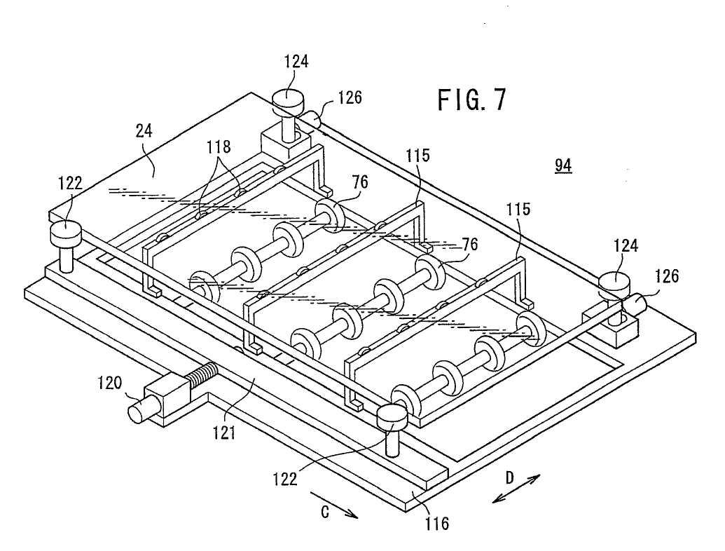

As shown in FIG. 7, the positioning mechanism 94 has a lifting base 116 that is vertically movable by an actuator, not shown. The positioning mechanism 94 also has a plurality of support posts 115 mounted on the lifting base 116 and extending transversely across the glass substrate 24 in the direction indicated by the arrow D. A plurality of slide rollers 118 whose axes extend perpendicularly to the axes of the feed rollers 76 are mounted on each of the support posts 115.

A movable plate 121 which is movable in the direction indicated by the arrow D by a motor 120 is mounted on an end portion of the lifting base 116 in the direction indicated by the arrow D. A pair of reference width limiting rollers 122 is rotatably mounted on the movable plate 121 at opposite ends thereof in the direction indicated by the arrow C in which the glass substrate 24 is fed.

A pair of width limiting rollers 124 aligned with the respective reference width limiting rollers 122 is rotatably mounted on an opposite portion of the lifting base 116 in the direction indicated by the arrow D. The width limiting rollers 124 are movable in the direction indicated by the arrow D by respective cylinders 126. Rather than the pair of width limiting rollers 124, a single width limiting roller 124 may be disposed at a central portion of the glass substrate 24 in the direction in which it is fed. The single width limiting roller 124 can accurately position the glass substrate 24 with respect to the reference width limiting rollers 122 even if the glass substrate 24 is deformed in shape. Instead of the single width limiting rollers or roller 124, a combination of cylinders and springs or only springs may be used to press the glass substrate 24 against the reference width limiting rollers 122.

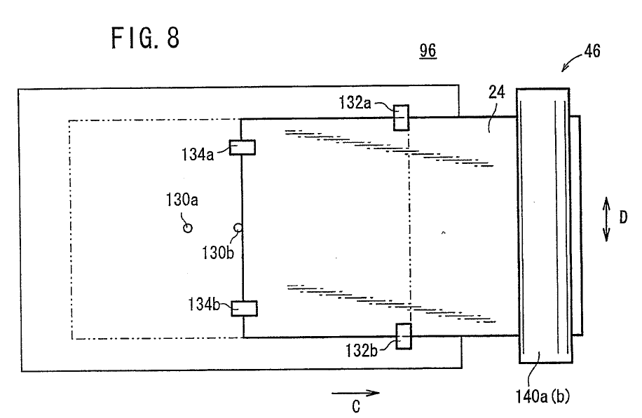

As shown in FIG. 8, the stopping mechanism 96 has a speed reduction sensor 130a for detecting when the trailing end of a glass substrate 24 moves thereacross, and a stopping sensor 130b for detecting the trailing end of the glass substrate 24 when the leading end of the glass substrate 24 is placed in a prescribed laminating position.

The stopping mechanism 96 also has heat-resistant linear sensors 132a, 132b, 134a, 134b for detecting whether the glass substrate 24 is positioned and stopped at a given posture in the fifth heating furnace 90. The heat-resistant linear sensors 132a, 132b detect the positions of transversely opposite ends of the glass substrate 24 and determine whether the detected positions fall in a predetermined range or not. The heat-resistant linear sensors 134a, 134b detect the stopped position of the glass substrate 24 and determine whether the detected position falls in a predetermined range or not.

Each of the heat-resistant linear sensors 132a, 132b, 134a, 134b comprises a light-transmitting element and a light-detecting element which are disposed one on each side of the glass substrate 24, and outputs a position-detecting analog signal in proportion to the amount of light that is blocked by the glass substrate 24. However, each of the heat-resistant linear sensors 132a, 132b, 134a, 134b may be a sensor for detecting a position through an image processing process.

The heating apparatus 45 monitors the temperature of glass substrates 24 at all times. In the event that the heating apparatus 45 detects an abnormal temperature, the heating apparatus 45 stops the feed rollers 76 or issues a warning, and transmits malfunctioning information which may be used to eject an abnormal glass substrate 24 and may also be used for quality control or production management.

The feed mechanism 74 may have an air-lifting plate, not shown, for lifting glass substrates 24 while they are being fed in the direction indicated by the arrow C.

As shown in FIG. 1, a substrate storage frame 136 for storing a plurality of glass substrates 24 is disposed upstream of the heating apparatus 45. The substrate storage frame 136 has dust removing fan units (or duct units) 137 disposed on respective three sides except for a charging slot and a discharging slot thereof. The fan units 137 eject electrically neutralizing clean air into the substrate storage frame 136. The glass substrates 24 stored in the substrate storage frame 136 are attracted one by one by suction pads 139 on a hand 138a of a robot 138, taken out from the substrate storage frame 136, and inserted into the receiver 78.

The bonding mechanism 46 has a pair of vertically spaced laminating rubber rollers 140a, 140b that are heated to a predetermined temperature. Backup rollers 142a, 142b are held in rolling contact with the respective laminating rubber rollers 140a, 140b. The backup roller 142b is pressed against the laminating rubber roller 140b by a roller clamp unit 144.

A contact prevention roller 146 is movably disposed near the rubber roller 140a for preventing the photosensitive web 22 from contacting the rubber roller 140a. A preheating unit 147 for preheating the photosensitive web 22 to a predetermined temperature is disposed upstream of and closely to the bonding mechanism 46. The preheating unit 147 comprises a heat applying means such as an infrared bar heater or the like.

Film feed rollers 148a and substrate feed rollers 148b are disposed between the bonding mechanism 46 and the inter-substrate web cutting mechanism 48. A cooling mechanism 150 is disposed downstream of the inter-substrate web cutting mechanism 48, and a base peeling mechanism 152 is disposed downstream of the cooling mechanism 150. The cooling mechanism 150 supplies cold air to a substrate 24a after the photosensitive web 22 is cut off between the substrate 24a and a following substrate 24a by the inter-substrate web cutting mechanism 48. Specifically, the cooling mechanism 150 supplies cold air having a temperature of 10° C. at a rate ranging from 1.0 to 2.0 m/min. However, the cooling mechanism 150 may be dispensed with, and the substrate 24a may be cooled in a photosensitive laminated body storage frame 166.

The base peeling mechanism 152 disposed downstream of the cooling mechanism 150 has a plurality of suction pads 154 for attracting the lower surface of a substrate 24a. While the substrate 24a is being attracted under suction by the suction pads 154, the base film 26 and the residual section 30b are peeled off from the substrate 24a by a robot hand 156. Electrically neutralizing air blowers (not shown) for ejecting electrically neutralizing air to four sides of the laminated area of the substrate 24a are disposed upstream, downstream, and laterally of the suction pads 154. The base film 26 and the residual section 30b may be peeled off from the substrate 24a while a table for supporting the substrate 24a thereon is being oriented vertically, obliquely, or turned upside down for dust removal.

The base peeling mechanism 152 is followed downstream by the photosensitive laminated body storage frame 166 for storing a plurality of photosensitive laminated bodies 160. A photosensitive laminated body 160 that is produced when the base film 26 and the residual section 30b are peeled off from the substrate 24a by the base peeling mechanism 152 is attracted by suction pads 164 on a hand 162a of a robot 162, taken out from the base peeling mechanism 152, and placed into the photosensitive laminated body storage frame 166.

The photosensitive laminated body storage frame 166 has dust removing fan units (or duct units) 137 disposed on respective three sides except for a charging slot and a discharging slot thereof. The fan units 137 eject electrically neutralizing clean air into the photosensitive laminated body storage frame 166.

In the manufacturing apparatus 20, the web reel-out mechanism 32, the processing mechanism 36, the label bonding mechanism 40, the reservoir mechanism 42, the peeling mechanism 44, the tension control mechanism 66, and the detecting mechanism 47 are disposed above the bonding mechanism 46. Conversely, the web reel-out mechanism 32, the processing mechanism 36, the label bonding mechanism 40, the reservoir mechanism 42, the peeling mechanism 44, the tension control mechanism 66, and the detecting mechanism 47 may be disposed below the bonding mechanism 46 to apply the photosensitive resin layer 28 to the lower surface of the glass substrate 24. Alternatively, the components of the manufacturing apparatus 20 may be arranged in a linear pattern as a whole.

The manufacturing apparatus 20 is controlled in its entirety by a lamination process controller 170. The manufacturing apparatus 20 also has a lamination controller 172, a substrate heating controller 174, and a base peeling controller 176, etc. for controlling the different functional components of the manufacturing apparatus 20. These controllers are interconnected by an in-process network.

The lamination process controller 170 is connected to the network of a factory, and performs information processing for production, e.g., production management and mechanism operation management, based on instruction information (condition settings and production information) from a factory CPU (not shown).

The lamination controller 172 serves as a process master for controlling the functional components of the manufacturing apparatus 20. The lamination controller 172 operates as a control mechanism for controlling the heating apparatus 45, for example, based on the positional information, detected by the detecting mechanism 47, of the partly cut regions 34 of the photosensitive web 22.

The base peeling controller 176 controls the base peeling mechanism 152 to peel off the base film 26 from the substrate 24a that is supplied from the bonding mechanism 46, and also to discharge the photosensitive laminated body 160 to a downstream process. The base peeling controller 176 also handles information about the substrate 24a and the photosensitive laminated body 160.

The installation space of the manufacturing apparatus 20 is divided into a first clean room 182a and a second clean room 182b by a partition wall 180. The first clean room 182a houses therein the various components ranging from the web reel-out mechanism 32 to the tension control mechanism 66. The second clean room 182b houses therein the detecting mechanism 47 and the other components following the detecting mechanism 47. The first clean room 182a and the second clean room 182b are connected to each other by a through region 184.

Operation of the manufacturing apparatus 20 for carrying out a heating method according to the present invention will be described below.

As shown in FIG. 1, in the processing mechanism 36, the circular blade 52 moves transversely across the photosensitive web 22 to cut into the protective film 30, the photosensitive resin layer 28, and the base film 26, thereby forming partly cut regions 34 (see FIG. 2). Then, the photosensitive web 22 is fed by a distance corresponding to the dimension of the residual section 30b of the protective film 30 in the direction indicated by the arrow A (see FIG. 1), and then stopped, whereupon other partly cut regions 34 are formed therein by the circular blade 52. As shown in FIG. 2, a front peel-off section 30aa and a rear peel-off section 30ab are now provided in the photosensitive web 22, with the residual section 30b interposed therebetween.

Then, the photosensitive web 22 is fed to the label bonding mechanism 40 to place a bonding area of the protective film 30 on the support base 56. In the label bonding mechanism 40, a predetermined number of adhesive labels 38 are attracted under suction and held by the suction pads 54b through 54e and are securely bonded to the front peel-off section 30aa and the rear peel-off section 30ab of the protective film 30 across the residual section 30b thereof (see FIG. 3).

The photosensitive web 22 with the five adhesive labels 38 bonded thereto, for example, is isolated by the reservoir mechanism 42 from variations of the tension to which the supplied photosensitive web 22 is subjected, and then continuously fed to the peeling mechanism 44. In the peeling mechanism 44, the base film 26 of the photosensitive web 22 is attracted to the suction drum 62, and the protective film 30 is peeled off from the photosensitive web 22, leaving the residual section 30b. The protective film 30 is peeled off at a sharp peel-off angle by the peeling roller 63 and wound by the protective film takeup unit 64. It is preferable to apply an electrically neutralizing air flow to the region where the protective film 30 is peeled off.

At this time, inasmuch as the photosensitive web 22 is firmly held by the suction drum 62, shocks produced when the protective film 30 is peeled off from the photosensitive web 22 are not transferred to the photosensitive web 22 downstream of the suction drum 62. Consequently, such shocks are not transferred to the bonding mechanism 46, and hence laminated sections of glass substrate 24 are effectively prevented from developing a striped defective region.

After the protective film 30 has been peeled off from the base film 26, leaving the residual section 30b, by the peeling mechanism 44, the photosensitive web 22 is adjusted in tension by the tension control mechanism 66, and then partly cut regions 34 of the photosensitive web 22 are detected by the photoelectric sensor 72 of the detecting mechanism 47.

Based on detected information of the partly cut regions 34, the film feed rollers 148a are rotated to feed the photosensitive web 22 a predetermined length to the bonding mechanism 46. At this time, the contact prevention roller 146 is waiting above the photosensitive web 22 and the rubber roller 140b is disposed below the photosensitive web 22.

In the heating apparatus 45, the heating temperatures in the first through fifth heating furnaces 82, 84, 86, 88, 90 are set to values depending on the lamination temperature in the bonding mechanism 46. For example, if the lamination temperature is 110° C., then the heating temperatures in the second through fifth heating furnaces 84, 86, 88, 90 are set to about 120° C., and the heating temperature in the first heating furnace 82 is set to 200° C. or higher. The upper limit temperature for the glass substrate 24 is set to 130° C. to keep the quality of the surface contact improver applied to the surface of the glass substrate 24.

Essentially, therefore, the first heater 98a is set to a heater temperature of about 250° C., and the second, fourth, and fifth heaters 98b, 98d, 98e are set to a heater temperature of about 130° C. In the third heating furnace 86, the third heater 98c is set to a heater temperature in the range from 125° C. to 130° C., and the auxiliary heater 100 is set to a heater temperature of about 115° C.

The robot 138 grips a glass substrate 24 stored in the substrate storage frame 136, and introduces the gripped glass substrate 24 into the receiver 78. In the receiver 78, the glass substrate 24 is turned to a desired angular position by the turntable 80. Then, the glass substrate is fed by the feed rollers 76 of the feed mechanism 74 from the receiver 78 to the first heating furnace 82 in the tact feed mode.

In the first heating furnace 82, the glass substrate 24 is quickly heated by the first heater 98a, as shown in FIG. 4. Then, the glass substrate 24 is delivered from the first heating furnace 82 into the second heating furnace 84 by the feed mechanism 74. A new glass substrate 24 which is subsequently introduced into the receiver 78 is delivered into the first heating furnace 82.

In the second heating furnace 84, the glass substrate 24 is gradually heated by the second heater 98b whose heater temperature is set to a value lower than that of the first heater 98a. After the glass substrate 24 is heated by the second heater 98b for a predetermined period of time, the glass substrate 24 is introduced into the third heating furnace 86 by the feed mechanism 74. In the third heating furnace 86, the glass substrate 24 is heated for a given period of time. Thereafter, the glass substrate 24 is sent by the feed mechanism 74 into the fourth heating furnace 88 in which the glass substrate 24 is heated and positioned.

The fourth heating furnace 88 houses therein the positioning mechanism 94. As shown in FIG. 7, the lifting base 116 is lifted by the non-illustrated actuator, and the slide rollers 118 supported on the lifting base 116 lift the glass substrate 24 off the feed rollers 76.

Then, the motor 120 is energized to move the reference width limiting rollers 122 toward one side of the glass substrate 24, and the reference width limiting rollers 122 support the side of the glass substrate 24, bringing the glass substrate 24 into a predetermined reference position. The cylinders 126 are actuated to move the width limiting rollers 124 toward the reference width limiting rollers 122. The width limiting rollers 124 are brought into contact with the opposite side of the glass substrate 24, pressing the glass substrate 24 against the reference width limiting rollers 122 thereby to position the glass substrate 24 transversely.

Then, the lifting base 116 is lowered to place the glass substrate 24 onto the feed rollers 76, after which the width limiting rollers 124 are spaced from the side of the glass substrate 24 and the reference width limiting rollers 122 are spaced from the other side of the glass substrate 24. The glass substrate 24, which has thus been processed in the fourth heating furnace 88, is delivered by the feed mechanism 74 into the fifth heating furnace 90 in which the glass substrate 24 is thermally insulated and stopped prior to being discharged.

The fifth heating furnace 90 houses therein the stopping mechanism 96. As shown in FIG. 8, when the trailing end of the glass substrate 24 moves across the speed reduction sensor 130a, the speed at which the glass substrate 24 is fed by the feed mechanism 74 is reduced. When the trailing end of the glass substrate 24 is detected by the stopping sensor 130b, the feeding of the glass substrate 24 is stopped.

The positions of the transverse edges (in the direction indicated by the arrow D) of the glass substrate 24 are detected by the heat-resistant linear sensors 132a, 132b, which determine whether the detected positions of the transverse edges of the glass substrate 24 fall in a predetermined range or not. The heat-resistant linear sensors 134a, 134b which are disposed at the trailing end of the glass substrate 24 determine whether the position of the trailing end of the glass substrate 24 in the direction in which the glass substrate 24 travels falls in a predetermined range or not.

If it is judged that the glass substrate 24 is stopped in a predetermined stop position within the fifth heating furnace 90, the glass substrate 24 is temporarily positioned between the rubber rollers 140a, 140b in alignment with the bonded region of the photosensitive resin layer 28 of the photosensitive web 22.

Then, the roller clamp unit 144 is operated to lift the backup roller 142b and the rubber roller 140b to clamp the glass substrate 24 under a predetermined pressure between the rubber rollers 140a, 140b. The rubber roller 140a is rotated to transfer, i.e., laminate, the photosensitive resin layer 28, which is melted with heat, to the glass substrate 24.

The photosensitive resin layer 28 is laminated onto the glass substrate 24 under such conditions that the photosensitive resin layer 28 is fed at a speed in the range from 1.0 m/min. to 10.0 m/min., the rubber rollers 140a, 140b have a temperature ranging from 100° C. to 140° C., and a hardness degree ranging from 40 to 90, and apply a pressure (linear pressure) ranging from 50 N/cm to 400 N/cm.

When the photosensitive web 22 has been laminated onto the leading glass substrate 24, the next glass substrate 24 in the fifth heating furnace 90 is placed between the rubber rollers 140a, 140b and stopped for a certain period of time. At the same time that the leading glass substrate 24 with the photosensitive web 22 laminated thereto is fed in the direction indicated by the arrow C, the photosensitive web 22 is laminated onto the next glass substrate 24.

After another glass substrate 24 has been positioned as described above in the fourth heating furnace 88, the other glass substrate 24 is fed from the fourth heating furnace 88 to the fifth heating furnace 90. When the lamination of the photosensitive web 22 on the previous glass substrate 24 is finished, the other glass substrate 24 is gripped between the rubber rollers 140a, 140b and temporarily stopped, after which the photosensitive web 22 is laminated onto the other glass substrate 24.

As shown in FIG. 1, the substrate 24a, which comprises the glass substrate 24 and the photosensitive web 22 bonded thereto, is fed a certain distance in the direction indicated by the arrow C, cooled by the cooling mechanism 150, and then delivered to the base peeling mechanism 152. In the base peeling mechanism 152, while the substrate 24a is being attracted by the suction pads 154, the base film 26 and the residual section 30b are peeled off by the robot hand 156, thereby producing a photosensitive laminated body 160.

At this time, electrically neutralizing air is being ejected to four sides of the laminated area of the substrate 24a from the air blowers disposed upstream, downstream, and laterally of the suction pads 154. The photosensitive laminated body 160 is held by the hand 162a of the robot 162 and placed into the photosensitive laminated body storage frame 166. The above operation is repeated until a predetermined number of photosensitive laminated bodies 160 are stored in the photosensitive laminated body storage frame 166.

According to the first embodiment, the first heating furnace 82 which is positioned upstream in the feeding direction as shown in FIG. 4, generates a greater amount of heat than that of the second heating furnace 84. The glass substrate 24 is quickly heated nearly to a target temperature of about 120° C. by the first heating furnace 82.

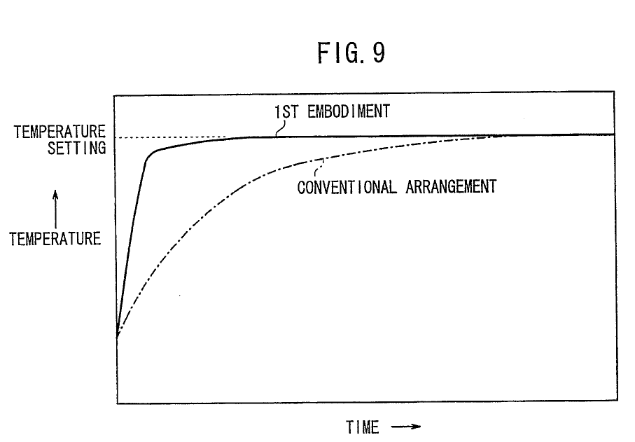

An experiment was conducted to detect respective temperature increasing patterns of a conventional heating apparatus which is devoid of the first heating furnace 82 as a high temperature furnace and whose all heater temperatures are set to about 130° C. and the heating apparatus 45. As shown in FIG. 9, according to the conventional heating apparatus, the glass substrate 24 was gradually heated, and it took a considerable period of time until the glass substrate 24 reached a desired target temperature of about 120° C.

According to the first embodiment which employs the first heating furnace 82 as a high temperature furnace, the glass substrate 24 was quickly heated to the target temperature by the first heating furnace 82, and the period of time required to heat the glass substrate 24 to the target temperature was much shorter. According to the first embodiment, therefore, the overall length of the first through fifth heating furnaces 82 through 90 is greatly reduced in the direction indicated by the arrow C, making it possible to reduced the overall size of the heating apparatus 45.

The second heating furnace 84, which generates a smaller amount of heat than that of the first heating furnace 82, and the third through fifth heating furnaces 86 through 90 are disposed downstream of the first heating furnace 82. Therefore, the glass substrate 24 which has been quickly heated closely to the target temperature by the first heating furnace 82 can accurately be heated to the target temperature by the second through fifth heating furnaces 84 through 90.

Even if the glass substrate 24 dwells in the second through fifth heating furnaces 84 through 90, it is not excessively heat up to an excessively high temperature of 130° C. or higher. Therefore, the heating apparatus 45 does no need a cooling device for cooling the glass substrate 24, and the quality of the surface contact improver applied to the surface of the glass substrate 24 is prevented from being deteriorated.

According to the first embodiment, furthermore, the third heating furnace 86 houses therein the retracting mechanism 92. When the manufacturing apparatus 20 needs to be serviced for maintenance to replace the photosensitive web roll 22a or due to shutdown of the manufacturing apparatus 20 caused by malfunction, even if glass substrates 24 are placed respectively in the first through fifth heating furnaces 82 through 90, the glass substrate 24 in the first heating furnace 82 can easily be removed therefrom.

Specifically, if glass substrates 24 are present respectively in the first through fifth heating furnaces 82 through 90, the motor 106 of the retracting mechanism 92 is energized to rotate the feed screws 108 to lift the support table 104, as shown in FIG. 5. The bearing pins 112 on the support posts 110 on the support table 104 are brought into abutment against the lower surface of the glass substrate 24, lifting the glass substrate 24 into the buffer 114.

Then, as shown in FIG. 4, the glass substrate 24 placed in the second heating furnace 84 is fed by the feed mechanism 74 into the third heating furnace 86 in which the glass substrate 24 is placed on the feed rollers 76. In the third heating furnace 86, therefore, the two glass substrates 24 are disposed in the upper and lower positions. The glass substrate 24 placed in the first heating furnace 82 is fed by the feed mechanism 74 into the second heating furnace 84.

Therefore, the five glass substrates 24 are placed in the second through fifth heating furnaces 84 through 90. Even if the glass substrates 24 dwell in the heating apparatus 45, they are reliably prevented from being heated to an excessively high temperature of 140° C. or higher. Consequently, the heating apparatus 45 does not need a cooling device for cooling the glass substrates 24 which would otherwise be excessively heated, and the quality of the surface contact improver applied to the surface of the glass substrate 24 is prevented from being deteriorated. After the glass substrates 24 are recovered from the dwelling state, the glass substrates 24 that are kept near the target temperature can quickly be supplied to the bonding mechanism 46. The operation of the manufacturing apparatus 20 is thus performed highly efficiently.

In the first embodiment, the glass substrates 24 are fed in the tact feed mode, i.e., a batch feed mode. However, the glass substrates 24 may be fed continuously in the heating apparatus 45.

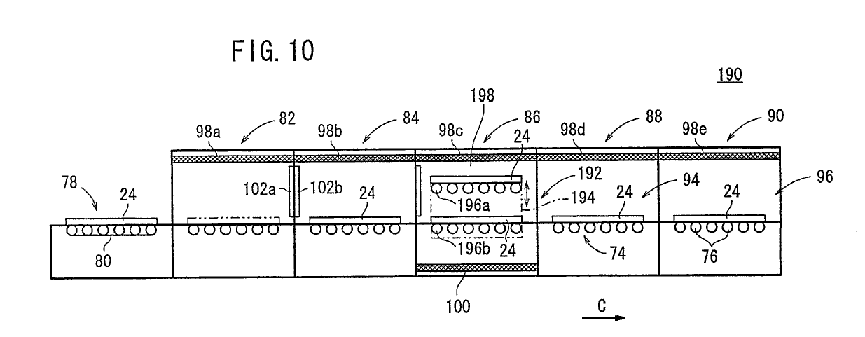

FIG. 10 schematically shows in side elevation a heating apparatus 190 according to a second embodiment of the present invention. Those parts of the heating apparatus 190 which are identical to those of the heating apparatus 45 according to the first embodiment are denoted by identical reference characters, and will not be described in detail below. Similarly, those parts of heating apparatus according to third through fifth embodiments to be described below which are identical to those of the heating apparatus 45 according to the first embodiment are denoted by identical reference characters, and will not be described in detail below.

As shown in FIG. 10, the heating apparatus 190 has a retracting mechanism 192 housed in the third heating furnace 86. The retracting mechanism 192 has a lifting base 194 with two sets of feed rollers 196a, 196b mounted thereon. The two sets of feed rollers 196a, 196b provide upper and lower feed conveyors, respectively. The retracting mechanism 192 has a buffer 198 for receiving a glass substrate 24 delivered upwardly (or downwardly) of the feed path of the feed mechanism 74.

According to the second embodiment, the lifting base 194 is normally disposed in a lower position (or an upper position) for feeding a glass substrate 24 supplied from the second heating furnace 84 to the third heating furnace 86, and then to the fourth heating furnace 88 with the feed rollers 196a (or the feed rollers 196b).

When glass substrates 24 dwell in the heating apparatus 190, the glass substrate 24 placed in the third heating furnace 86 is retracted into the buffer 198 by the lifting base 194 of the retracting mechanism 192 as it is lifted or lowered. The glass substrate 24 placed in the second heating furnace 84 is fed into the third heating furnace 86 by the feed rollers 196b (or the feed rollers 196a), and the glass substrate 24 placed in the first heating furnace 82 is fed into the second heating furnace 84. In the third heating furnace 86, therefore, the two glass substrates 24 are disposed in the upper and lower positions.

For delivering a glass substrate 24 from the heating apparatus 190 to the bonding position, the lifting base 194 is lowered (or lifted) and the glass substrate 24 on the feed rollers 196a (or the feed rollers 196b) is fed to the fourth heating furnace 88. Then, the lifting base 194 is lifted (or lowered) and the glass substrate 24 on the feed rollers 196b (or the feed rollers 196a) is fed to the fourth heating furnace 88.

According to the second embodiment, therefore, a glass substrate 24 that has previously been provided into the heating apparatus 190 is temporarily placed in the buffer 198 in the third heating furnace 86, and then fed to the fourth heating furnace 88 prior to a next glass substrate 24. Therefore, glass substrates 24 can be fed into and out of the third heating furnace 86 on a first-in, first-out basis for easy and reliable management of the glass substrates 24.

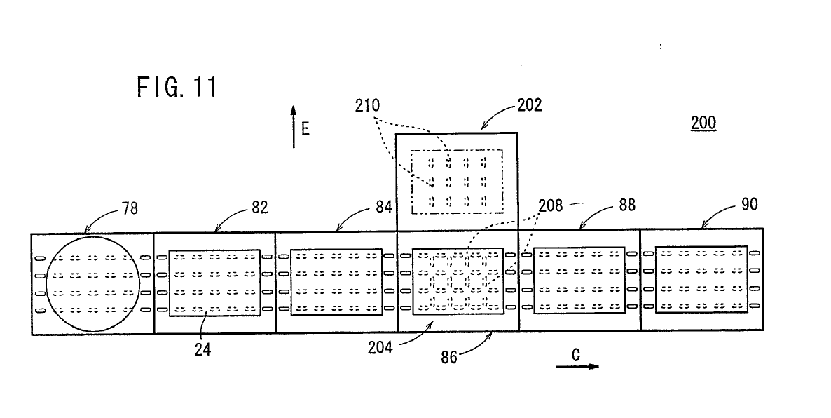

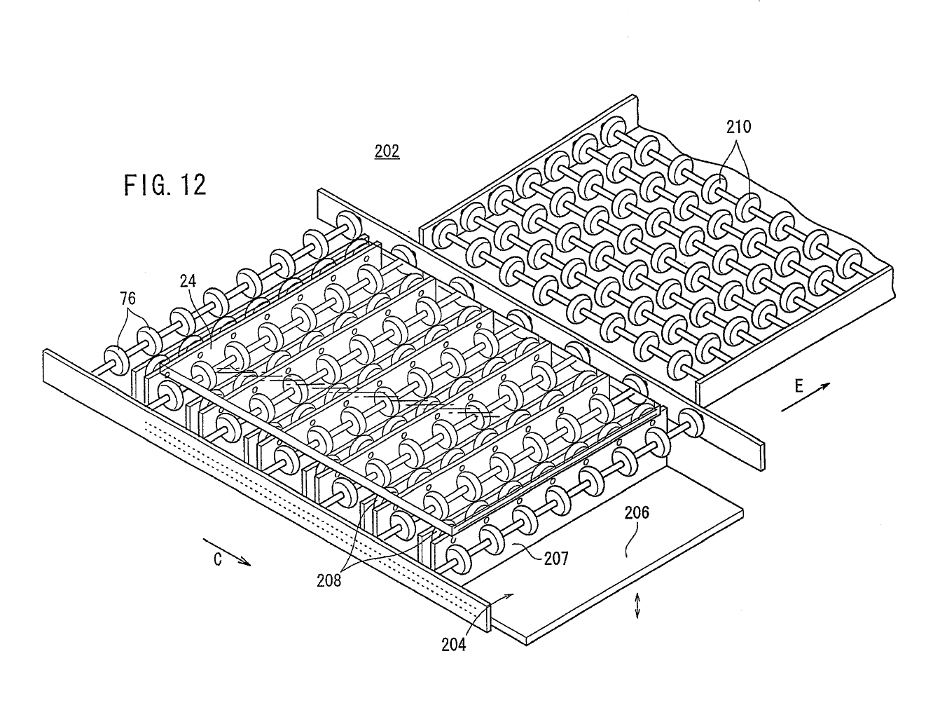

FIGS. 11 and 12 show a heating apparatus 200 according to a third embodiment of the present invention.

As shown in FIG. 11, the heating apparatus 200 has a buffer 202 projecting laterally from the third heating furnace 86 in the direction indicated by the arrow E. As shown in FIGS. 11 and 12, the third heating furnace 86 has a retracting mechanism 204 having a support base 206 that is vertically movable by an actuator, not shown. A plurality of rotatable rollers 208 whose axes extend perpendicularly to the axes of the feed rollers 76 are mounted on the support base 206 by guide plates 207.

The buffer 202 has a plurality of support rollers 210 for receiving a glass substrate 24 from the rollers 208 and transferring a glass substrate 24 to the rollers 208.

According to the third embodiment, when glass substrates 24 dwell in the heating apparatus 190, the glass substrate 24 placed in the third heating furnace 86 is supported by the rollers 208 by the support base 206 of the retracting mechanism 204 as it is lifted. Then, the glass substrate 24 is retracted into the buffer 202 by the rollers 208 as they are rotated. The glass substrate 24 in the second heating furnace 84 is fed into the third heating furnace 86, and the glass substrate 24 in the first heating furnace 82 is fed into the second heating furnace 84.

According to the third embodiment, therefore, glass substrates 24 are prevented from being placed continuously beyond a certain period of time in the first heating furnace 82 as a high-temperature furnace, and hence are prevented from being excessively heated, as with the first embodiment.

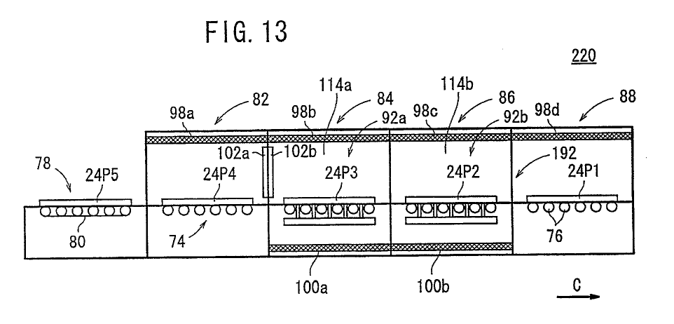

FIGS. 13 through 17 schematically show a heating apparatus 220 according to a fourth embodiment of the present invention.

As shown in FIG. 13, the heating apparatus 220 has a first retracting mechanism 92a housed in the second heating furnace 84 and a second retracting mechanism 92b housed in the third heating furnace 86. The first and second retracting mechanisms 92a, 92b have first and second buffers 114a, 114b, respectively. The second and third heating furnaces 84, 86 have respective auxiliary heaters 100a, 100b positioned below the feed mechanism 74.

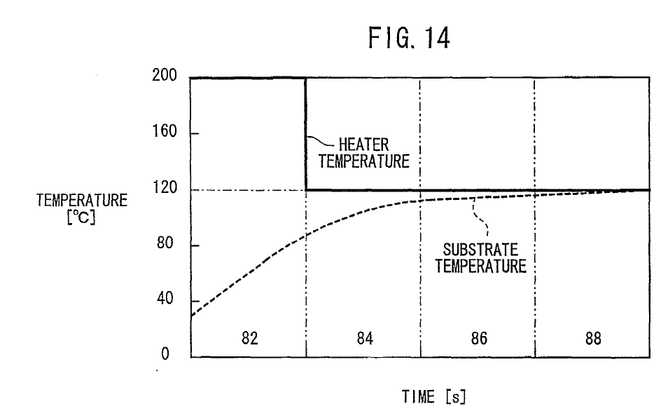

The fourth heating furnace 88 may double as a positioning mechanism and may also have a stopping mechanism so as to double as a fifth heating furnace. The temperatures set in the first through fourth heating furnaces 82 through 88 and the manner in which the temperature of the glass substrate 24 increases are shown in FIG. 14.

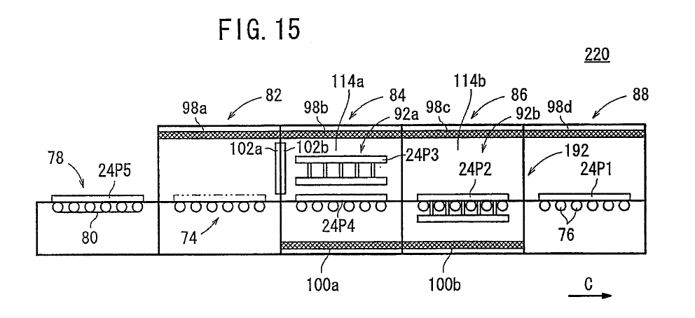

According to the fourth embodiment, five glass substrates 24P1 through 24P5 are normally placed in the heating apparatus 220 in the sequence by which they have been provided into the heating apparatus 220. When it is judged that the glass substrate 24P4 is heated longer than a predetermined period of time in the first heating furnace 82 as a high-temperature furnace, the first retracting mechanism 92a is lifted to retract the glass substrate 24P3 into the first buffer 114a and the glass substrate 24P4 is fed from the first heating furnace 82 into the second heating furnace 84, as shown in FIG. 15. Therefore, the glass substrate 24P4 is prevented from dwelling in the first heating furnace 82 beyond a certain period of time.

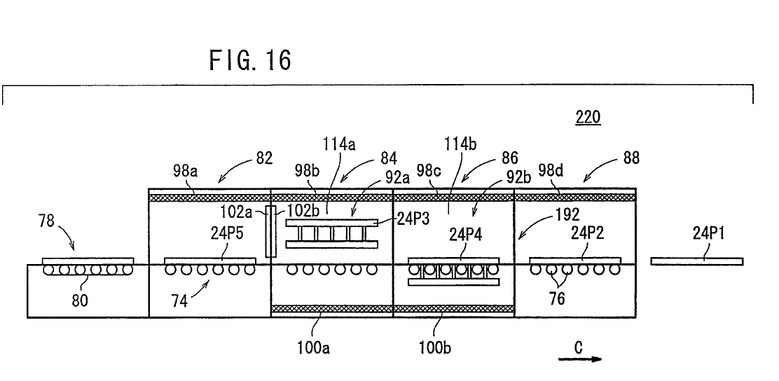

For successively delivering glass substrates 24P1, etc. from the heating apparatus 220 to the bonding position, the feed mechanism 74 is actuated to discharge the glass substrate 24P1 from the fourth heating furnace 88, to feed the glass substrate 24P2 from the third heating furnace 86 to the fourth heating furnace 88, to feed the glass substrate 24P4 from the second heating furnace 84 to the third heating furnace 86, and to feed glass substrate 24P5 to the first heating furnace 82, as shown in FIG. 16.

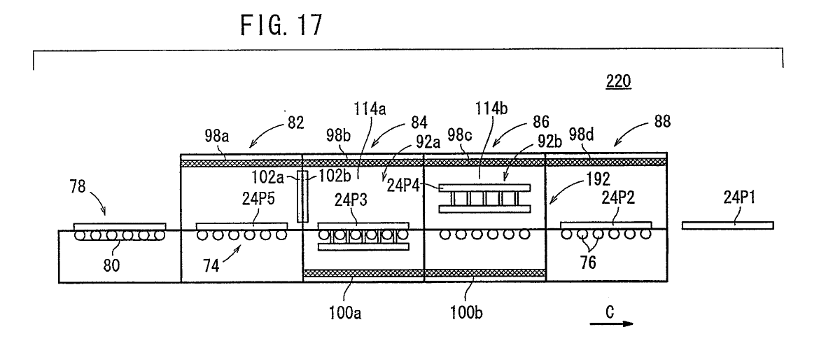

Then, as shown in FIG. 17, the glass substrate 24P3 placed in the buffer 114a of the second heating furnace 84 is lowered back onto the feed mechanism 74. The glass substrate 24P4 fed into the third heating furnace 86 is retracted into the second buffer 114b by the second retracting mechanism 92b.

The glass substrate 24P3 in the second heating furnace 84 is fed into the third heating furnace 86 by the feed mechanism 74, and then delivered from the fourth heating furnace 88 to the bonding position, after the glass substrate 24P1 and the glass substrate 24P2 have been delivered. Thereafter, the glass substrate 24P4 retracted in the second buffer 114b of the third heating furnace 86 is returned to the feed mechanism 74, and then delivered from the fourth heating furnace 88 to the bonding position, after the glass substrate 24P3 has been delivered.

According to the fourth embodiment, therefore, the glass substrates 24P1 through photosensitive web provided into the heating apparatus 220 are delivered to the bonding position in the sequence by which they are provided into the heating apparatus 220, and can be fed into and out of the heating apparatus 220 on a first-in, first-out basis, as with the second embodiment.

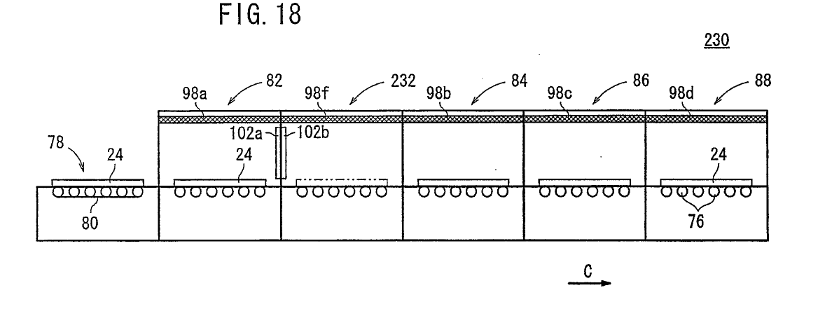

FIG. 18 schematically shows in side elevation a heating apparatus 230 according to a fifth embodiment of the present invention.

As shown in FIG. 18, the heating apparatus 230 has a buffer heating furnace (buffer) 232 disposed between the first heating furnace 82 and the second heating furnace 84. The buffer heating furnace 232 has a heater 98f.

According to the fifth embodiment, when the heating apparatus 230 is in normal operation, a glass substrate 24 which has been heated for a given period of time in the first heating furnace 82 moves through the buffer heating furnace 232 between the first and second heating furnaces 82, 84 and is fed into the second heating furnace 84, in which the glass substrate 24 is heated for a predetermined period of time. Only when it is judged that a glass substrate 24 has been heated beyond the given period of time in the first heating furnace 82, the glass substrate 24 is delivered from the first heating furnace 82 into the buffer heating furnace 232 and waits in the buffer heating furnace 232 until the normal heating operation of the heating apparatus 230 is resumed.

According to the fifth embodiment, the heating apparatus 230 is of a simple and compact structure, prevents the glass substrate 24 from being kept in the first heating furnace 82 beyond a given period of time, and hence prevents the glass substrate 24 from being excessively heated, as with the first through third embodiments.

Although certain preferred embodiments of the present invention have been shown and described in detail, it should be understood that various changes and modifications may be made therein without departing from the scope of the appended claims.

1-13. (canceled)

14. An apparatus for heating a workpiece, comprising:
a feed mechanism for feeding the workpiece in a feeding direction; and
at least first and second heating furnaces disposed along said feeding direction;
wherein said first heating furnace is disposed upstream of said second heating furnace with respect to said feeding direction and has a first heat source for heating said workpiece to at least a target temperature required for processing the workpiece; and
said second heating furnace capable of generating a smaller amount of heat than that of said first heating furnace is disposed downstream of said first heating furnace with respect to said feeding direction and has a second heat source for heating said workpiece to a temperature lower than said target temperature.

15. An apparatus according to claim 14, wherein either said second heating furnace or one of heating furnaces including a third heating furnace disposed downstream of said second heating furnace with respect to said feeding direction has a retracting mechanism for retracting said workpiece from said feed mechanism.

16. An apparatus according to claim 15, wherein said retracting mechanism includes a buffer for receiving said workpiece delivered vertically or horizontally in a direction perpendicular to said feeding direction.

17. An apparatus according to claim 14, further comprising:
a buffer disposed downstream of said first heating furnace with respect to said feeding direction, for holding said workpiece or a downstream workpiece to wait therein only when it is judged that said workpiece has been heated beyond a predetermined period of time in said first heating furnace.

18. An apparatus according to claim 14, wherein said feed mechanism continuously or intermittently feeds said workpiece.

19. An apparatus according to claim 14, wherein either said second heating furnace or one of heating furnaces including a third heating furnace disposed downstream of said second heating furnace with respect to said feeding direction has a positioning mechanism for positioning said workpiece transversely thereof in a direction transverse to said feeding direction.

20. An apparatus according to claim 19, further comprising:
a stopping mechanism disposed downstream of said positioning mechanism with respect to said feeding direction, for stopping said workpiece in a predetermined position along said feeding direction.

21. A method of heating a workpiece while intermittently or continuously feeding the workpiece along a feed path, comprising the steps of:
heating said workpiece to a temperature equal to or lower than a target temperature with a first heating furnace disposed in an upstream area with respect to said feeding direction and being capable of heating said workpiece to at least the target temperature required for processing the workpiece; and
heating said workpiece to a temperature equal to or lower than said target temperature with a second heating furnace disposed in a downstream area with respect to said feeding direction and being capable of generating a smaller amount of heat than that of said first heating furnace.

22. A method according to claim 21, wherein a buffer for retracting said workpiece from said feed path is disposed in either said second heating furnace or one of a plurality of heating furnaces including a third heating furnace disposed downstream of said second heating furnace with respect to said feeding direction, further comprising the steps of:
when it is judged that said workpiece has been heated beyond a predetermined period of time in said first heating furnace, delivering said workpiece or another workpiece from said feed path into said buffer, and discharging said workpiece from said first heating furnace.

23. A method according to claim 22, wherein said buffer is disposed transversely to said feed path, further comprising the steps of:
when it is judged that said workpiece has been heated beyond a predetermined period of time in said first heating furnace, delivering a previously provided first workpiece into said buffer, thereafter placing a subsequently provided second workpiece in parallel to said first workpiece, returning said first workpiece to said feed path, separating said second workpiece from said feed path, then feeding said first workpiece along said feed path, thereafter returning said second workpiece to said feed path, and feeding said second workpiece along said feed path after said first workpiece.

24. A method according to claim 22, wherein said buffer comprises first and second buffers arranged along said feed path, further comprising the steps of:
when it is judged that said workpiece has been heated beyond a predetermined period of time in said first heating furnace, delivering a previously provided first workpiece from said feed path into said first buffer, thereafter delivering a subsequently provided second workpiece through said first buffer into said second buffer, returning said first workpiece from said first buffer to said feed path, feeding said first workpiece downstream along said feed path, then returning said second workpiece from said second buffer to said feed path, and feeding said second workpiece along said feed path after said first workpiece.

25. A method according to claim 21, wherein a buffer is disposed downstream of said first heating furnace with respect to said feeding direction, further comprising the step of:
only when it is judged that said workpiece has been heated beyond a predetermined period of time in said first heating furnace, holding said workpiece or a downstream workpiece to wait in said buffer.

26. A method according to claim 21, further comprising the steps of:
positioning said workpiece transversely thereof in a direction transverse to said feeding direction in either said second heating furnace or one of a plurality of heating furnaces including a third heating furnace disposed downstream of said second heating furnace with respect to said feeding direction; and
stopping said workpiece in a predetermined position along said feeding direction, and thereafter detecting whether said workpiece is stopped in said predetermined position or not.
